(19) United States
(12) Patent Application Publication
(10) Pub. No.: US 2009/0299796 A1
(43) Pub. Date: Dec. 3, 2009

(54) CONFIGURATION OF RESOURCES FOR AN ENTITY

(75) Inventors: Samarth Sharath Pai, Bellevue, WA (US); Angela S. Wise, Seattle, WA (US); Roderick C. Paulino, Renton, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/129,691

(22) Filed: May 30, 2008

(51) Int. Cl. G06Q 10/00; G06F 17/30

(52) U.S. Cl. 705/8; 707/5; 707/E17.009

(57) ABSTRACT

A set-up facilitating system assists an entity (such as a business entity) in providing one or more resources, including one or more network-accessible resources. The set-up facilitating system begins by identifying initial information regarding the entity. The set-up facilitating systems then uses the initial information to glean additional information from one or more sources. The initial information and additional information are used to automatically provision the resources, such as a network-accessible page, review-related information, an ad program, service, etc.

### BACKGROUND

An administrator or owner of a business may appreciate the wisdom of expanding the business's presence to the Internet or other network environment. An administrator may approach this task by essentially building network-accessible resources “from scratch.” As broadly used herein, such network-accessible resources may encompass network-accessible pages (e.g., web pages), ad campaigns, services, and so on.

However, various factors may prevent or delay an administrator from setting up a network-accessible resource. For instance, an administrator may lack sufficient knowledge (and hence confidence) to design a network-accessible resource. In addition, or alternatively, the administrator may lack sufficient free time to devote to the task of designing a network-accessible resource. This may be the case even for a computer-savvy administrator, since the task of designing a network-accessible resource is potentially complex, tedious, and subject to error. The administrator may also need to interact with several different resource providers to build a complete suite of resources, adding to the complexity of this project. In addition, or alternatively, a non-technical administrator may simply lack the requisite interest level to perform this task.

The administrator can address the above challenges by gaining appropriate design skills to create a desired resource. However, as stated above, the administrator may still lack the free time and interest to generate the resource. An administrator, of course, can hire an expert to assist in setting up a network-resource. Yet this solution is not always optimal, as professional assistance may be costly, and the performance of such assistance may be uneven.

As a result of these challenges, many businesses may fail to exploit the full potential of network-related resources. Any type of business may confront the above difficulties, but these difficulties may be particularly pronounced in the case of small business enterprises. Other entities may face similar challenges, such as non-profit organizations, and so on.

### SUMMARY

An illustrative approach is described for configuring one or more resources on behalf of an entity, such as, not limited to, a business entity. The approach begins by collecting initial seed information from the entity. Based on this initial information, the approach collects additional information regarding the entity from various information sources. The initial information and the additional information are collectively referred to as entity information herein. The approach uses the entity information to generate at least one resource for the entity. The resource may correspond to a network-accessible resource.

In one illustrative case, as a resource, the approach can provide a network-accessible page (e.g., a web page) based on the entity information.

In another illustrative case, as a resource, the approach can cull one or more reviews associated with the entity from a plurality of sources. The approach can then give the entity an opportunity to take action with respect to these reviews, such as by incorporating the reviews into a network-accessible page provided by the entity.

In another illustrative case, as a resource, the approach can provide one or more ad program recommendations.

In another illustrative case, as a resource, the approach can provide or recommend one or more tools (such as a scheduling tool) that may be used by the entity.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative set-up facilitating system for automatically provisioning a resource.

FIG. 2 shows an illustrative module for generating a particular type of resource.

FIG. 3 shows one illustrative network-related implementation of the set-up facilitating system of FIG. 1.

FIG. 4 shows an illustrative introductory page provided by the set-up facilitating system of FIG. 1, asking the user to confirm initial seed information associated with the entity.

FIG. 5 shows an illustrative master set-up page provided by the set-up facilitating system of FIG. 1, inviting the user to select among different resources to be configured.

FIG. 6 shows a proposed illustrative network (e.g., web) page generated by the set-up facilitating system of FIG. 1.

FIG. 7 shows an illustrative information collection page provided by the set-up facilitating system of FIG. 1 for soliciting additional information regarding the entity.

FIG. 8 shows an illustrative ad administration page that provides a collection of ad program recommendations to the user from which to choose, among other features.

FIG. 9 shows an illustrative ad configuration page that invites the user to specify further details regarding an entity under consideration.

FIG. 10 shows an illustrative proposed ad page that can be used to solicit information from the entity's customers.

FIG. 11 is another view of the ad administration page of FIG. 8, in this case showing information populated under an “active” ad program category.

FIG. 12 is a flowchart that shows an illustrative method for generating one or more resources for an entity based on initial seed information.

FIG. 13 shows illustrative processing functionality that can be used to implement any aspect of the features shown in the foregoing drawings.

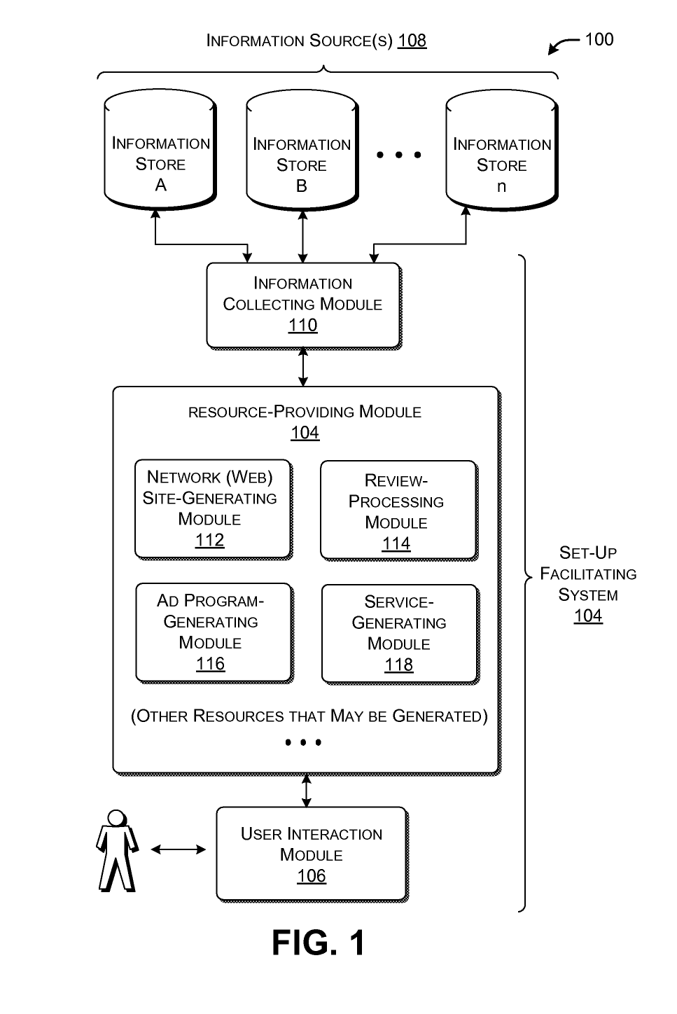

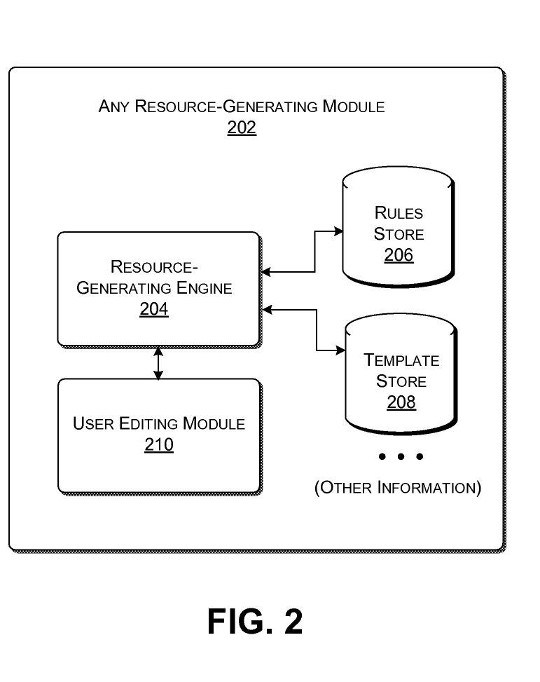

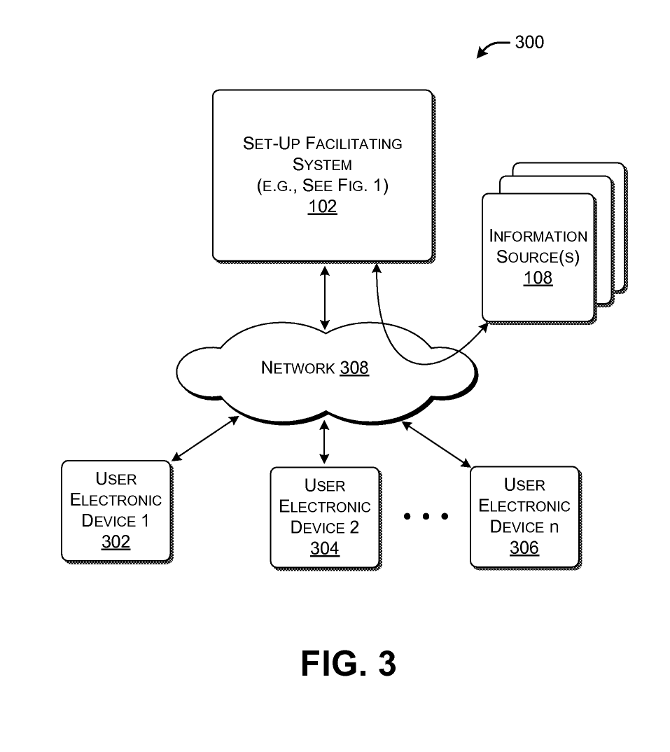

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure describes an approach for assisting a business entity or other entity in setting up one or more resources, including one or more network-accessible resources. The approach automatically provisions parts of a resource without the assistance of the user or with minimal user assistance. This aspect of the approach may help a business overcome its reluctance to generate and launch the resource. More generally, the concepts disclosed herein may address one or more of the challenges or problems previously noted, but are not limited to addressing all or any of these challenges or problems.

As used herein, the term “user” is typically used to describe the person who interacts with a set-up facilitating system to generate one or more resources. The user may be an administrator of a business, an owner of a business, or any other person associated with the business or acting on behalf of the business.

The term “entity” as used here may refer to any type of business entity of any structure and any size (including a sole proprietor). The term “entity” also encompasses other organizations, such as non-profit organizations, clubs, societies, etc. of any type, purpose, and size. The term “entity” can also encompass a single individual or a loosely affiliated group of people who might want a network presence for any reason, including reasons unrelated to the running of a business. However, to facilitate discussion, the examples which follow will address the use of the set-up facilitating system principally in the context of a business entity, particularly, but not limited to, the case of a small business enterprise.

As mentioned above, the term “resource” is intended to encompass a broad array of features, including, but not limited to, network (“web”) sites, network-implemented ad programs, traditional (non-network-implemented) ad programs, customer reviews guidance, various services and tools, and so on.

This disclosure is organized as follows. Section A describes illustrative systems for automatically provisioning aspects of one or more resources. Section B describes illustrative methods for performing the same function. Section C describes illustrative processing functionality that can be used to implement any aspect of the features described in Sections A and B.

A. Illustrative Systems

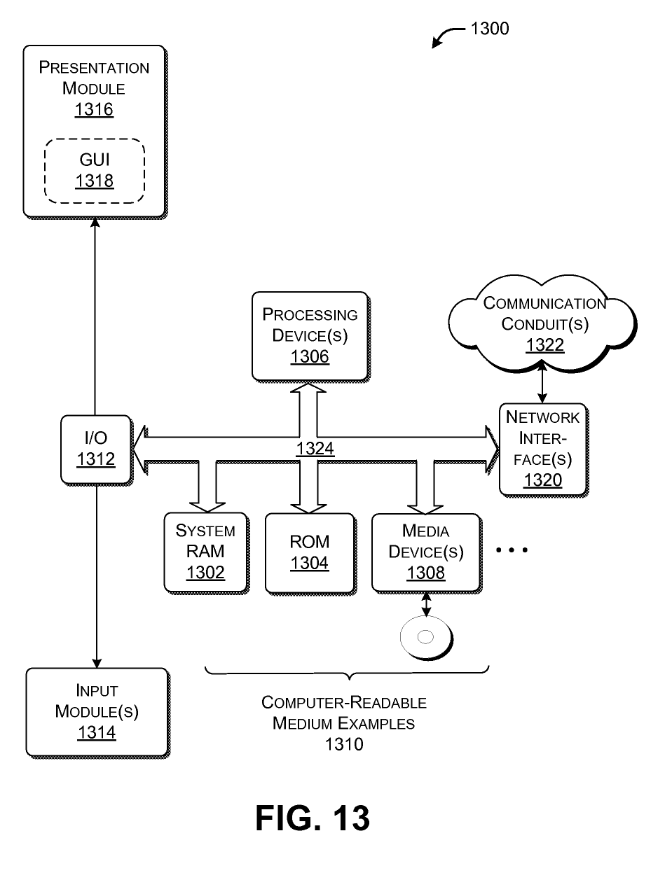

As a preliminary matter, the various components shown in the figures can be implemented in any manner, for example, by software, hardware, firmware, manual processing operations, and so on, or any combination of these implementations. The phrase “configured to” refers to any way of providing a function, and may encompass any implementation or combination thereof (software, hardware, firmware, manual processing operations, and so on). FIG. 13, to be discussed in turn, provides additional details regarding one illustrative implementation of the functions shown in the figures.

In one case, the illustrated separation of various components in the figures into distinct units may reflect the use of corresponding distinct physical components. Alternatively, or in addition, the depiction of any two or more separate components in the figures may reflect different functions performed by a single physical component. Alternatively, or in addition, the depiction of any single component in the figures may be implemented by two or more physical components.

FIG. 1 shows an illustrative set-up environment 100 that includes a set-up facilitating system 102. The set-up facilitating system 102 automatically provisions one or more resources, including one more network-accessible resources. More specifically, the set-up facilitating system 102 includes a resource-providing module 104 for generating one or more resources. The resource-providing module 104, in turn, can include one or more component resource-generating modules for generating particular respective types of resources, each to be described below in turn.

As will be discussed (with reference to FIG. 3), the system-providing module can be implemented as a network-accessible service. A user can interact with the resource-providing module 104 via a user interaction module 106. In a physical implementation, the user interaction module 106 may comprise the frontend component of a network-accessible system which delivers services to the user in a series of user interface presentations. The user's electronic device (not shown in FIG. 1) interacts with these user interface presentations via a network (e.g., a wide area network, such as the Internet) using browsing functionality.

In performing its provisioning functions, the resource-providing module 104 can interact with a collection of information sources 108 using an information collecting module 110. The information collecting module 110 operates by first identifying initial seed information regarding the business (where the business is referred to as an “entity” for generality below). For example, in order to use the set-up facilitating system 102, the user may be asked to register with this service. As part of that registration process, the user may be asked to provide relatively minimal information regarding the entity that it represents. For instance, in the case that the entity is a business entity, the user may be asked to specify the name of the business and its mailing code (e.g., in the United States, the zip code of the business). In one example, the above-mentioned initial seed information may comprise this initially collected information, e.g., the business name and zip code.

The information collecting module 110 uses the initial seed information to automatically determine additional information regarding the entity. In other words, the information collecting module 110 uses the initial seed information to expand its knowledge regarding the entity. To this end, the information collecting module 110 interacts with the information sources 108 to extract information provided by these information sources 108 that may be relevant to the entity.

More specifically, the information sources 108 may comprise one or more network-accessible public information repositories and/or one or more network-accessible private information repositories. For example, one information source (or sources) may provide information regarding any one or more of the entity's address, phone number, business hours, etc. Another information source (or sources) may provide information regarding the professional credential's of the entity (if the entity pertains to a professional service). Another information source (or sources) may provide customer reviews regarding the goods or services provided by the entity. Another information source (or sources) may provide information regarding any existing network-accessible resources provided by the entity itself (such as web sites, etc.). Another information source (or sources) may provide information regarding news stories, blogs, etc. that mention the entity. Another information source (or sources) may provide governmental information regarding the entity (such as whether the entity is licensed, whether there are any outstanding complaints regarding the entity, and so on). Another information source (or sources) may provide intellectual property information regarding the entity, such as information regarding any trademarks, logos, copyrights, patents, etc. associated with the entity, and so on. No limitation is placed on the types of information sources that may be useful in gleaning information regarding an entity, such as a business. As used herein, the combination of the initial seed information and any additional information that is collected from the information sources 108 is referred to as “entity information.”

Returning to the resource-providing module 104, this module uses the entity information to automatically or semi-automatically configure one or more resources for the entity. As stated, the resource-providing module 104 relies on a collection of component resource-generating modules to generate different types of resources. Some of the possible resources and associated modules are described below in introductory fashion. Later figures and accompanying discussion provide additional details regarding each of these component modules.

A network site-generating module 112 uses the entity information to generate a network-accessible site for the entity. The network-accessible site may comprise one or more pages that describe the services offered by the entity. Different network-accessible sites may be appropriate for different types of entities. But, in general, a network-accessible site may comprise a home page and one or more pages devoted to specific topics, such as “about us” page, a “contact us” page, a “site map” page, and so on.

A review-processing module 114 uses the entity information to cull customer reviews regarding the entity's products and/or services from one or information sources 108 (using the information collecting module 110). The review-processing module 114 may alert the user to the existence of these reviews. The review-processing module 114 may also give the user the option to take action with respect to these reviews. In one such action, the user may be given the opportunity to post one or more reviews to the entity's network-accessible site. In another such action, the user may be given links that can be activated to reply to the respective reviews.

An ad program-generating module 116 uses the entity information to provide one or more ad program recommendations to the user. Each ad program recommendation provides a proposal for marketing the goods and/or services provided by the entity. Some types of ad program recommendations may pertain to network-related approaches to marketing the goods and/or services. Other types of ad program recommendations may pertain to traditional approaches to marketing the goods and/or services (such as direct mail approaches). The user may select one or more ad program recommendations. The ad program-generating module responds by automatically activating the ad programs associated with the selected recommendations. The ad-program-generating module also may provide functionality that allows the user to monitor and manage ongoing ad programs.

A service-generating module 118 uses the entity information to provide one or more services for use by the entity. Such services encompass a wide variety of tools, applications, etc. that may be useful to the entity in carrying out its particular line of business. For instance, the service-generating module 118 can provide a scheduling program to a professional service entity for use by its customers in scheduling appointments with the entity. Other such services may include docketing tools, accounting tools, price quote tools, electronic payment tools, credit verification tools, bidding tools, and so on. In one case, the service-generating module 118 can operate by suggesting one or more services provided by either the resource-providing module 104 itself or some other provider. The service-generating module 118 can provide appropriate links to such services. In addition, or alternatively, the service-generating module 118 can also assist a user in configuring or customizing such services especially for the entity under consideration.

The group of resource-generating modules shown in FIG. 1 is illustrative and non-exhaustive. Other implementations may include additional resource-generating modules. In addition, or alternatively, other implementations may omit one or more resource-generating modules shown in FIG. 1.

FIG. 2 shows additional details regarding any type of resource-generating module 202, depicted in FIG. 2 in generic form. The resource-generating module 202 may include resource-generating engine 204. The resource-generating engine 204 may make use of various rules stored in a rules store 206 and various templates stored in a template store 208. The resource-generating module uses this information to automatically generate a resource based on the entity information. As stated above, the entity information may encompass initial seed information associated with the entity (such as the name of the entity and its mailing code), together with additional information gleaned from the information source 108. A user editing module 210 may allow the user to edit the resource provided by the resource-generating engine 204 in any manner.

The way in which the resource-generating engine 204 operates is resource-specific and application-specific. In general, however, the resource-generating feature may operate by mapping the entity information to one or more resource features based on rules and templates. Some of the rules may be structured in an “IF-THEN” type of format. For example, a first rule may state that, if the entity information includes the business type descriptor “accountant,” then the entity is a professional service. A second rule may state that, if the entity is a profession service, then the most appropriate network site for this entity is a specified type of professional network site, which, in turn, corresponds to one or more stock site templates. Based on this information, the resource-generating engine 204 can then select the appropriate network site template from the template store 208. The resource-generating engine 204 can then fill in the blank fields of the template with information specified by the entity information. For example, a template may include placeholder fields to accept an entity's address, telephone number, office hours, logo, and so on. A template may also include placeholder fields to accept a textual description of the entity. A template may also include placeholder fields to accept pictorial information associated with the entity, and so on. The resource-generating module 202 fills in these placeholder fields with information provided by the entity information.

The above example pertains to the design of a network site using the network site-generating module 112. But the same concepts apply to the generation of other types of resources. For example, assume again that the entity information suggests that the entity is an accounting firm. In the case of the ad program-generating module 116, the resource-generating engine 204 can use this insight as a look-up key to determine the types of ad programs that are most suitable for professional firms in general, and/or accounting firms in particular. The resource-generating engine 204 may suggest one or more of these ad programs to the user for his or her selection.

In other words, the template store 208 may organize a plurality of ad programs using different categories. A first category may group together ad programs that may be appropriate for any business entity. Other categories may correspond to groups of ad programs that may be appropriate for specific types of business entities. For instance, one category may specify ad programs that may be appropriate to professional services, another category may specify ad programs that may be appropriate to trade-related services, another category may specify ad programs that may be appropriate to retail services, and so on.

A common type of network-implemented ad program may operate by presenting an ad when one or more predefined keywords are present. The keywords, for instance, may be presented by a customer when performing a search. In addition, or alternatively, the keywords may be present in the type of network content that the customer is viewing. In addition, or alternatively, the keywords may be present in an Email message that the customer is viewing, and so on. In this case, the resource-generating engine 204 can suggest one or more keywords for a proposed ad program. The resource-generating engine 204 can perform this task by extracting keywords from the entity information which characterize the entity. For example, the information collecting module 110 may discover that the business entity is an accounting firm that specializes in tax preparation. Two appropriate keywords may therefore be “accountant” and “tax preparation.”

Consider next the case of the service-generating module 118. This module 118 can rely on a type of rules store 206 which maps a list of occupations with a list of tools that may be useful to various occupations. For example, upon determining that the entity in question is an accounting firm, the resource generating engine 204 of the service-generating module 118 can use the keyword “accountant” to determine that tools X, Y, and Z may be useful to this entity. The resource-generating engine 204 may suggest these tools to the user, providing appropriate links that allow the user to find out more about these services and to set up these services.

Some of the rules may dynamically reflect the choices made by the user in the past, or the choices made by many users. For example, the resource-generating module 202 may note that a significant proportion of its users who represent a certain type of business entity select an option X, rather than an option Y or an option Z. The resource-generating module 202 can respond to this pattern of behavior by most prominently offering option X to a user who represents that type of business entity.

In one case, a human or group of humans may manually create the information provided in the rules store 206 and template store 208, e.g., based on their skilled insight regarding the ways in which entity information may appropriately map to specific types of resources. Alternatively, or in addition, functionality can be provided to automatically investigate active network-related resources currently being providing by various business entities, e.g., by “crawling” the Internet for this information. The functionality can note patterns in these practices for different types of business entities. For example, the functionality may note that many web sites for plumbers include specific types of information presented therein, and that certain Internet ads for chiropractors make certain types of offers triggering by certain types of keywords, and so on. The functionality can then translate these patterns into resource-generating rules, e.g., by providing rules that map specific characteristics regarding a business (that may be specified in the entity information) to specific types of resources. The functionality can also propose templates for specific respective types of business entities based on common themes that it discovers are being used by these types of business entities. A human or group of humans may optionally oversee the appropriateness of the rules and templates that are generated in the above-specified manner.

The resource-generating engine 204 can also incorporate more advanced tools for designing a resource, such as expert system tools, neural network tools, and so on.

Advancing to FIG. 3, this figure shows one illustrative system 300 that can be used to implement the set-up facilitating system 102. The system 300 implements the set-up facilitating system 102 in a network environment. In the network environment, users may access the set-up facilitating system 102 using respective user electronic devices (302, 304, . . . 306) via a network 308.

The user electronic devices (302, 304, . . . 306) can correspond to any type of data processing device or any combination of types of data processing devices. For instance, a user electronic device can be implemented by a desktop computer, a laptop computer, a personal data assistant (PDA) device, a mobile communication device, a set-top box, a game console device, and so on. Or the device can correspond to special-purpose equipment designed for interacting with the set-up facilitating system 102.

The network 308 may represent any type of mechanism for allowing the user electronic devices (302, 304, . . . 306) to interact with the set-up facilitating system 102. The network 308 can correspond to a wide area network (such as the Internet), a local area network (LAN), a point-to-point connection, or any combination of connectivity mechanisms. The network 308 can be physically implemented using any combination of hardwired links, wireless links, name servers, gateways, routers, and so on (not shown). The network 308 can be governed by any protocol or combination of protocols.

In one scenario, the functionality associated with the set-up facilitating system 102 may be entirely implemented by network-accessible functionality, e.g., as implemented by one or more computer-type servers, data stores, and other data processing equipment. Alternatively, or in addition, parts of the set-up facilitating system 102 can be implemented locally by the user electronic devices (302, 304, . . . 306). Still other implementations are possible.

FIG. 3 also shows, as explained above, that the set-up facilitating system 102 can interact with one or more information sources 108. As indicated in FIG. 3, these information sources 108 can comprise network-accessible resources that the set-up facilitating system 102 can interact with via the network 308.

The next series of figures illustrate representative user interface (UI) pages that the set-up facilitating system 102 can deliver to the user. The pages provide information to the user and allow the user to interact with the set-up facilitating system 102. Various aspects of these pages are merely illustrative (including the content delivered by the pages, the look and feel of the pages, the sequence in which the pages are delivered, and so on). Other implementations can provide a series of pages that differ from the pages shown here in any respect.

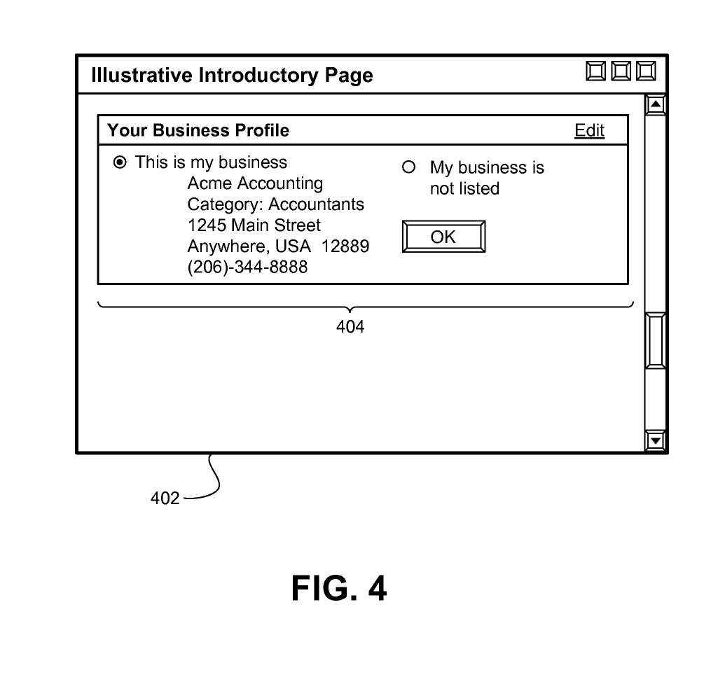

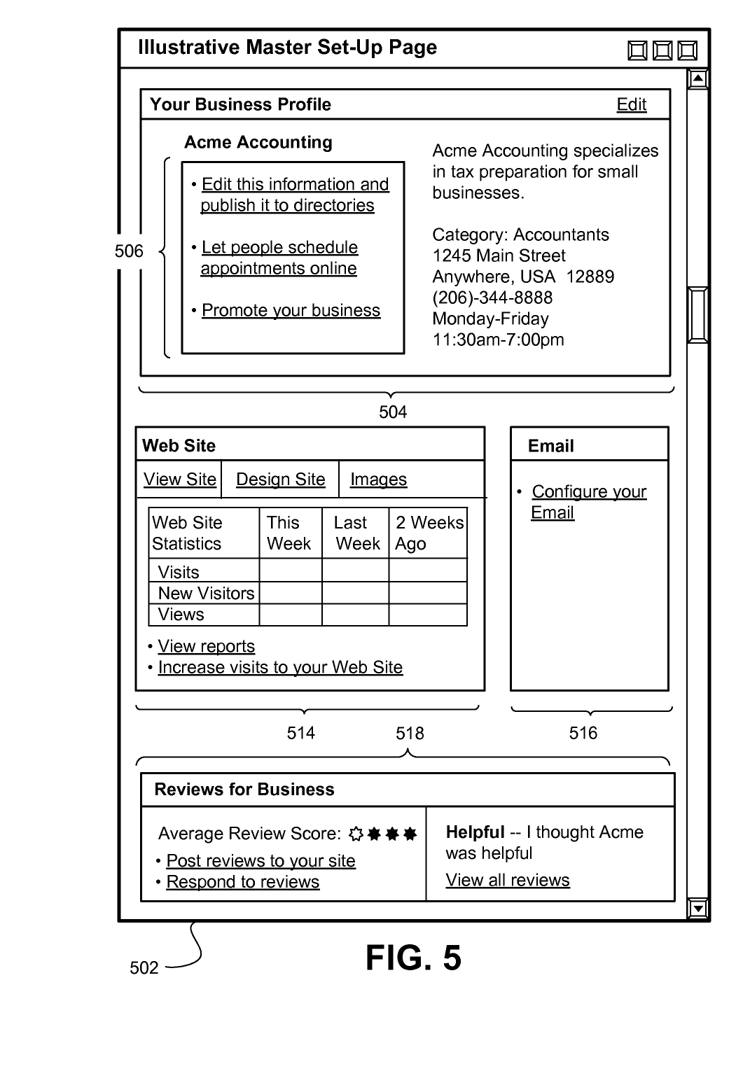

To begin with, FIG. 4 shows an illustrative introductory page 402 provided by the set-up facilitating system 102 of FIG. 1. As mentioned above, the user may have supplied seed information as part of a prior registration process. For example, the user may have specified the name of the business entity and the zip code of the business entity. Based on this information, the set-up facilitating system 102 consults the information sources 108 to extract additional information regarding the business entity. The introductory page 402 includes a confirmation section 404 that presents at least part of the collected information regarding the business entity, namely, the business entity's name, address, and telephone number. The confirmation section 404 asks the user to confirm whether the identified information is correct, e.g., by activating the “OK command. In this example, the user has confirmed that the information is in fact correct. In some cases, the set-up facilitating system 102 may present plural business entries corresponding to different business entities (because it may not be able to decisively resolve which business entity is correct for a particular user, if any). The user can select the appropriate entry (if it is present) and then activate the “OK” command. Upon receiving this confirmation, the set-up facilitating system 102 presents a master set-up page 502 to the user as shown in FIG. 5.

Advancing to FIG. 5, the master set-up page 502 includes plural sections corresponding to different resources that the business entity may decide to set up. The master set-up page 502 invites the user to configure any of these resources by interacting with the corresponding section(s). At this point, the set-up facilitating system 102 has determined that the business entity is an accounting firm. Accordingly, from this point on, the set-up facilitating system 102 can present various set-up pages and options that are specifically tailored to professional services in general, and optionally accounting services in particular. This applies to the master set-up page 502. Namely, the master set-up page 502 can convey design options which are particularly tailored to a professional service.

A first section 504 presents a business profile of the entity, which provides compiled information regarding the business entity. The set-up facilitating system 102 may have extracted at least part of the compiled information from the information sources 108. In this example, the compiled information specifies that the business entity is an accounting firm which specializes in a particular type of accounting practice. The compiled information can provide the address and telephone number of the business entity, as well as the office hours of the business entity.

The first section 504 also includes a number of selectable options 506. The user can click on (or otherwise select) any of these options 506 to invoke corresponding functionality. A first option (“Edit this information . . . ”) invokes functionality that allows the user to edit the business profile. A user may decide to perform this task if the user determines that the business profile as listed is incorrect and/or incomplete. The first option also may invoke functionality that allows the user to publish the business profile to various directories. A second option (“Let people schedule appointments online”) invites the user to invoke functionality for setting up a scheduling service for the business entity. The scheduling service will allow customers to schedule appointments in an online manner with the business entity. The first section 504 can, alternatively, or in addition, propose other services. A third option (“Promote your business”) invites the user to invoke functionality for setting up an ad program for the business entity (to be discussed below).

Another section 514 includes a number of selectable options for interacting with the entity's network site (e.g., web site). That is, if the site in fact already exists, this section 514 allows the user to view the site by activating the “View Site” command. The user can also view images associated with the site by activating the “Images” command. The user can also view statistics regarding the use of the site by viewing a table provided inline within this section 514. The section 514 also includes an option (“View reports”) that allows the user to view additional reports regarding the performance of the site. The section 514 also includes an option (“Increase visits to your Web Site”) that invokes functionality for setting up a network-related ad programs for the business entity (to be described below).

Presume, in another case, that the business entity does not yet have a network site. In this case, the user can invoke a command (“Design Site”) that invokes functionality for designing the entity's network site. More specifically, this selection invokes the provisioning assistance provided by the set-up facilitating system 102 (to be described below).

Another section 516 provides an option that can be invoked that allows the user to configure an Email service (or other communication service) associated with the business entity.

Another section 518 shows one or more reviews identified by the set-up facilitating system 102. The information collecting module 110 of the set-up facilitating system 102 may have extracted these reviews from one or more publicly available information sources 108. The information collecting module 110 can perform this task using various techniques. For instance, the information collecting module 110 can submit search terms to appropriate information sources 108 to extract relevant reviews therefrom. For example, the search terms can include any one or more of the name of the business entity, the names of entity's products and/or services, the names of the entity's owners and/or employees, and so on.

The section 518 may also include a number of selectable options associated with the displayed reviews. For example, one option (“Post reviews to your site”) allows the user to select one or more reviews and post these reviews to its network site (presumably, these are favorable reviews of its products and/or services). Another option (“Respond to reviews”) allows the user to select and respond to any of the reviews. For example, for each review, this option may provide a link to the information source from which the review originates. The user may activate this option to access the information source and respond to the review.

Thus, it can be seen that the master set-up page 502 provides a master portal or command center for both designing one or more resources and then for subsequently monitoring the performance of these resources. To repeat, the sections and options shown in FIG. 5 are merely representative. Other implementations can present other types of design interfaces.

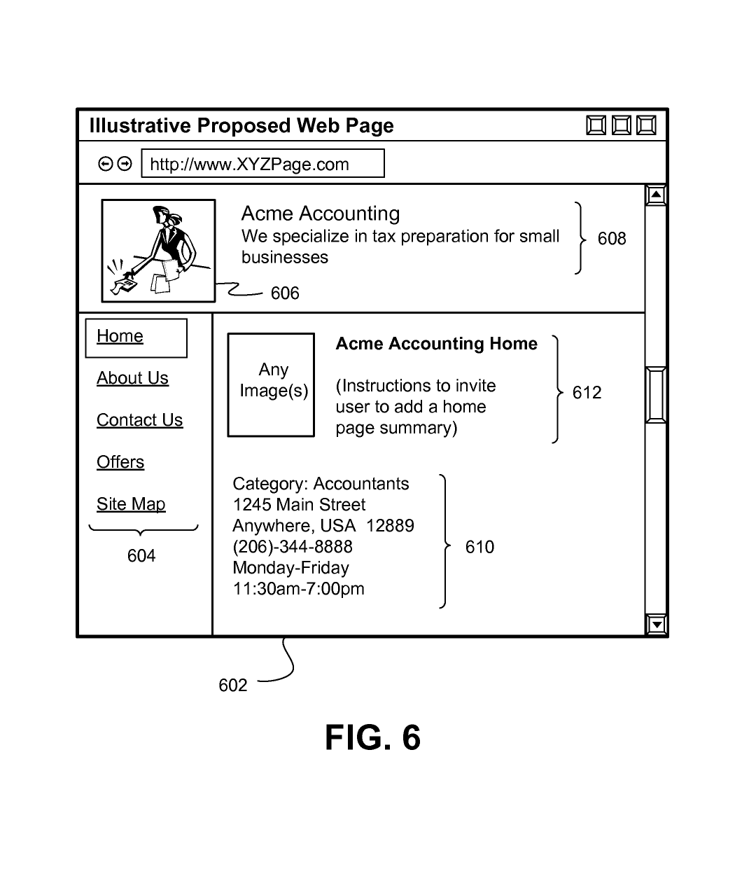

Presume that the user activates the “Design Site” command within section 514 of the master set-up page 502. In response, the set-up facilitating system 102 uses the entity information to automatically generate a proposed network site for the user. FIG. 6 shows one representative network (e.g., web) page 602 generated by the set-up facilitating system 102.

Advancing to FIG. 6, the network page 602 corresponds to a proposed home page for the business entity. The set-up facilitating system 102 can generate this page 602 by first noting that the business entity is an accounting firm. The set-up facilitating system 102 can then consult the rules store 206 to determine what type of network site is appropriate for an accounting firm. Based on this information, the set-up facilitating system 102 can then select the appropriate template(s) provided in the template store 208 to build an appropriate network site. Then the set-up facilitating system 102 can use the entity information to fill in input fields within the selected template(s). The final result is the proposed network page 602 shown in FIG. 6.

In the merely representative case of FIG. 6, the network page 602 includes a first section 604 which presents a menu of different pages provided within the proposed network site. The network page 602 includes other sections which provide introductory information regarding the entity (since this is a home page). The introductory information may include a stock picture 606 selected from the template store 208 that is deemed appropriate for the accounting field. The introductory information can also include expertise information 608 which describes the specialty of the business entity. The introductory information can also include contact information 610 which specifies the business entity's name, address, telephone number, office hours, and so on.

The network page 602 may also include one or more open-ended sections 612 which invite the user to manually supply additional information regarding the entity. For example, these sections 612 may invite the user to supply pictorial (image-related) and textual content pertaining to the entity. These sections thus allow the user to customize the network page 602 in any manner deemed suitable by the user. The user may also modify the other parts of the network page 602 that have been automatically provisioned by the set-up facilitating system 102.

Assume next that, within the master set-up page 502 of FIG. 5, the user activates the option “Promote your business” (within the selectable options 506) or the option “Increase visits to your Web Site” (within the section 514). This selection invokes functionality that presents various ad program recommendations to the user. The user may select an ad program (or programs) from among these recommendations. The process of setting up an ad program may involve a sequence of pages.

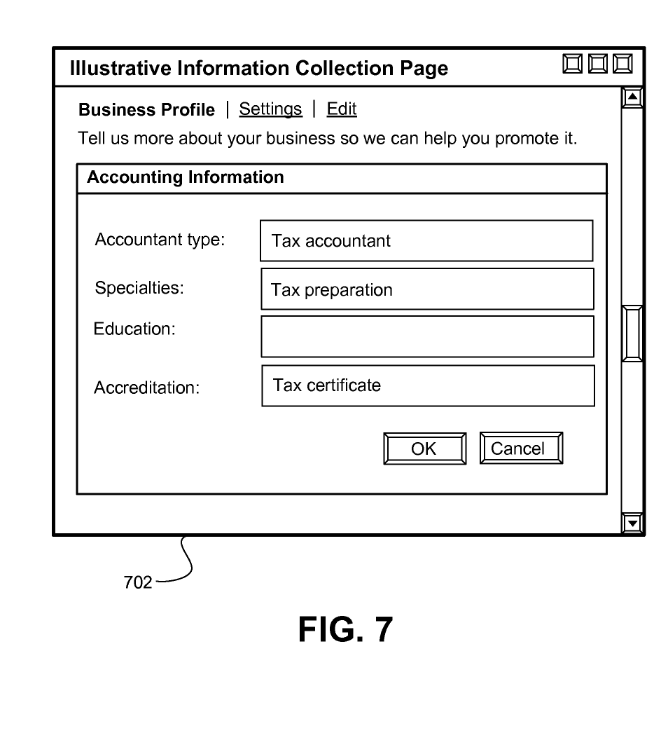

For instance, FIG. 7 shows an information collection page 702 that can be presented to the user at the outset of the ad design process. The information collection page 702 may optionally ask the user to provide additional information regarding the characteristics of the entity. This will allow the set-up facilitating system 102 to generate ad program recommendations which are more appropriately tailored to the nature of the resources provided by the business entity. In the instant case, the information collection page 702 asks the user to describe the type of the entity under consideration, the specialty of the entity, the education of the entity's employees, the accreditation of the entity, and so on. These choices are merely representative; other implementations can request different information. Further, the set-up facilitating system 102 can present a different set of questions for different types of entities. For example, a user setting up an ad program for an accountant may receive a first set of questions, while a user who is acting on behalf of a plumber may receive a second set of questions.

Having optionally collected additional information, the set-up facilitating system 102 uses this information (together with the other entity information that it has automatically collected) to generate one or more ad program recommendations. Each recommendation describes an ad program that can be selected by the user to advertise the entity's goods and/or services.

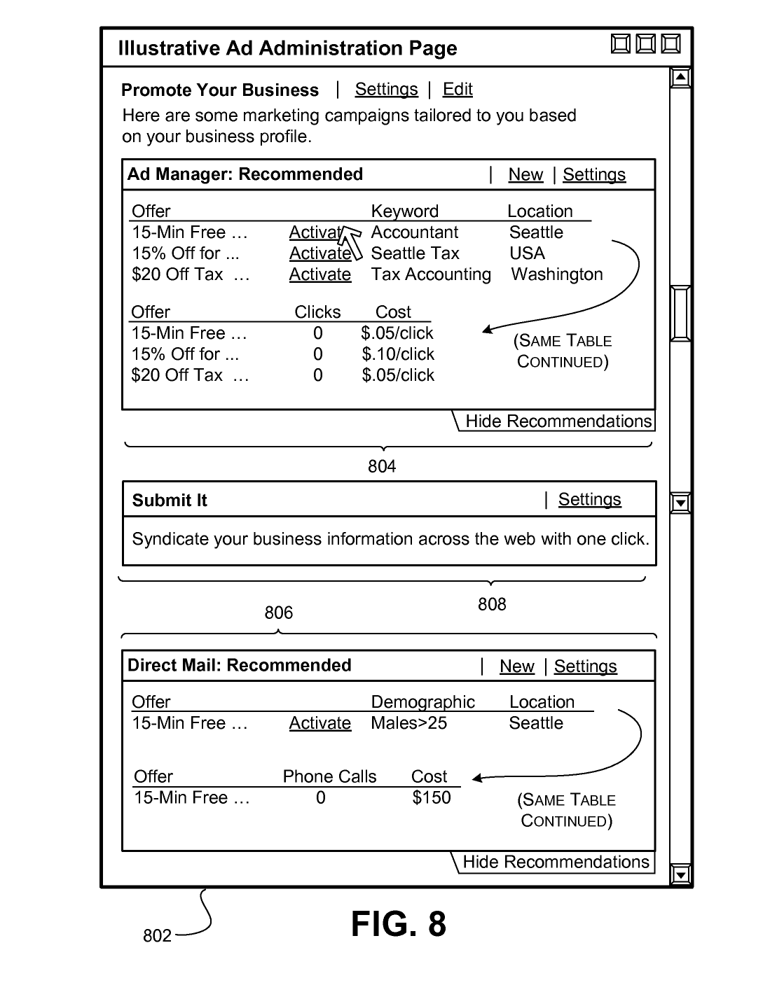

FIG. 8 shows an illustrative ad administration page 802 that identifies various ad program recommendations in different sections. A first section 804 provides recommendations pertaining to various network-related ad programs. For instance, these ad programs may relate to advertising material that is provided over a network (e.g., the Internet) in response to the presence of certain keywords. The keywords may appear in a search term that a customer has entered, a network page that the customer is viewing, an Email message that the customer is viewing, and so on.

The first section 804 provides its ad program recommendations in a table that has a number of fields. A first field describes the offer associated with each ad program. Another field identifies the keyword (or keywords) associated with each ad program. Another field identifies a geographical scope to which each ad program is directed (which is based on the entity's zip code). Another field identifies the number of clicks that each ad program has generated (which, for ad programs that have not yet been launched, will be zero). Another field identifies the cost associated with each ad program (e.g., in one business model, the cost may pertain to a maximum bid for a keyword, expressed in terms of cost per click). Each entry in the table also includes an “Activate” entry. The user can invoke one or more of the identified ad programs by selecting the “Activate” entry associated with the desired ad program(s). The selected ad program(s) become active at that time.

A second section 806 provides recommendations pertaining to various direct mail ad programs. The second section 806 also provides its ad recommendations in a table that has a number of fields. A first field describes the offer associated with each ad program. Another field identifies the demographic group to which each ad program is targeted. Another field identifies a geographical scope to which each ad program is directed. Another field identifies the number of phone calls that customers have made, as prompted by each ad program (which, for ad programs that have not yet been launched, will be zero). Another field identifies the cost associated with each ad program. Each entry in the table also includes an “Activate” entry. The user can invoke one or more of these ad programs by selecting the “Activate” entry associated with the desired ad program(s). The selected ad program(s) become active at that time.

A third section 808 allows a user to syndicate their business information across a wide area network, such as the Internet.

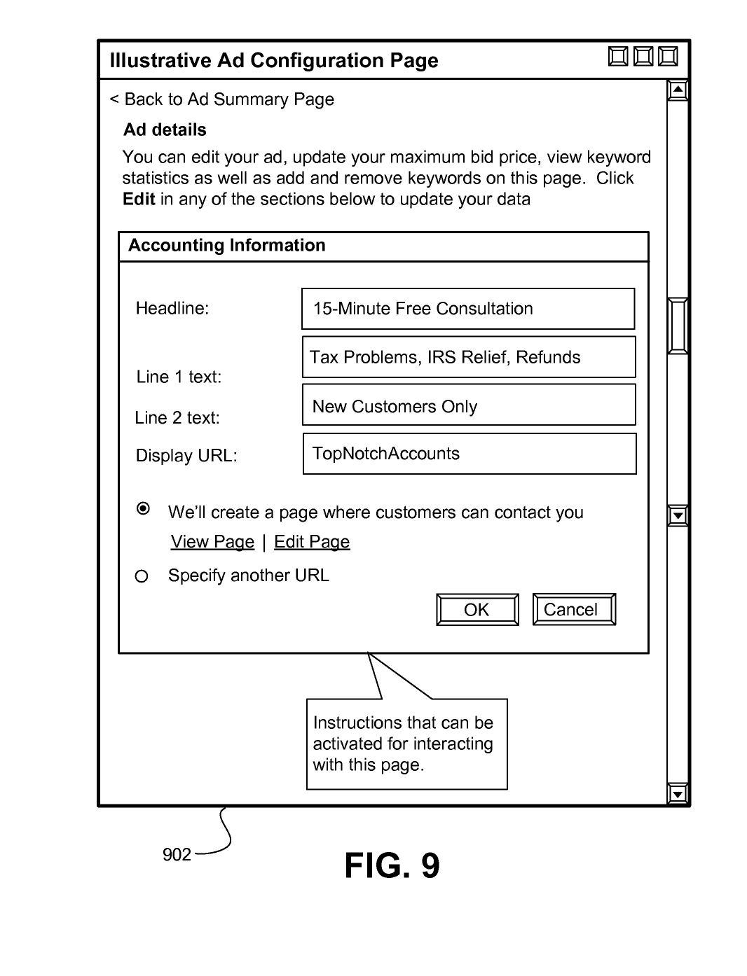

Assume that the user selects the ad program in section 804 that offers customers a free 15 minute consultation. In response, FIG. 9 shows an ad configuration page 902 that can be invoked, which allows the user to configure the selected ad program. In this case, the ad configuration page 802 allows the user to specify the title of the offer, the text of the offer, a network address (e.g., URL) associated with the offer, and so on. Further, the ad configuration page 902 can include an option “View Page” that allows the user to view a page that will be invoked by the ad program. The ad configuration page 902 can also include an option “Edit Page” that allows the user to edit the page that will be invoked by the ad program.

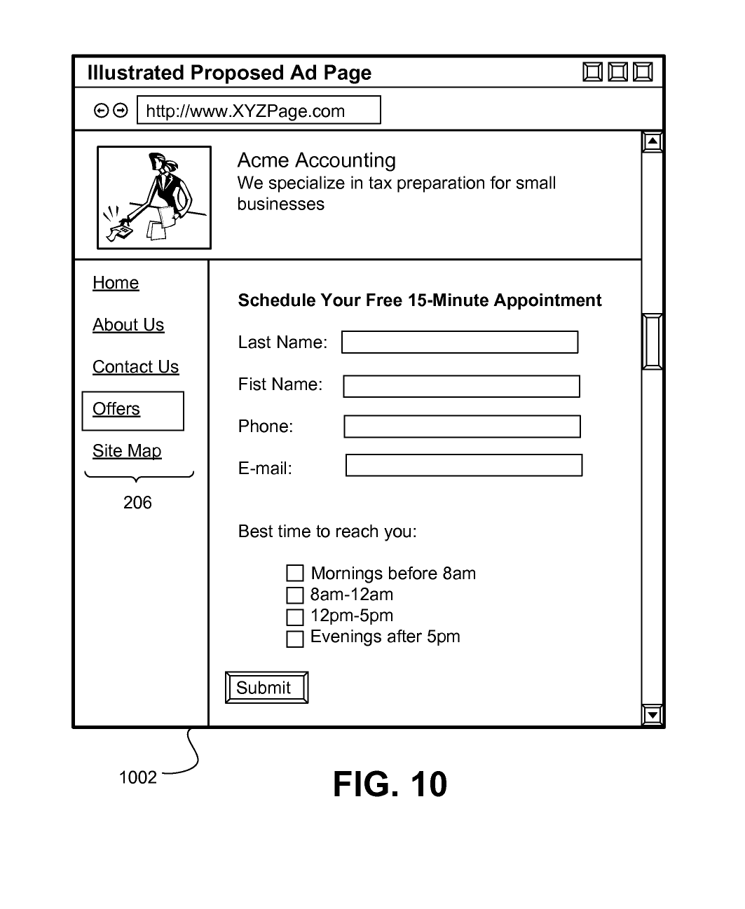

Assume that the user activates the “View Page” option. In response, FIG. 10 shows an illustrative proposed ad page 1002 that may be invoked, which will be displayed to the entity's customers. That is, the proposed ad page 1002 may be provided to the customer upon the presence of a relevant triggering keyword or keywords. The proposed ad page 1002 may also be incorporated as part of the entity's network site. The proposed ad page 1002 itself conveys an offer which invites a customer to sign up for a free 15-minute consultation. For this purpose, the proposed ad page 1002 includes input fields for receiving identifying information from the customer.

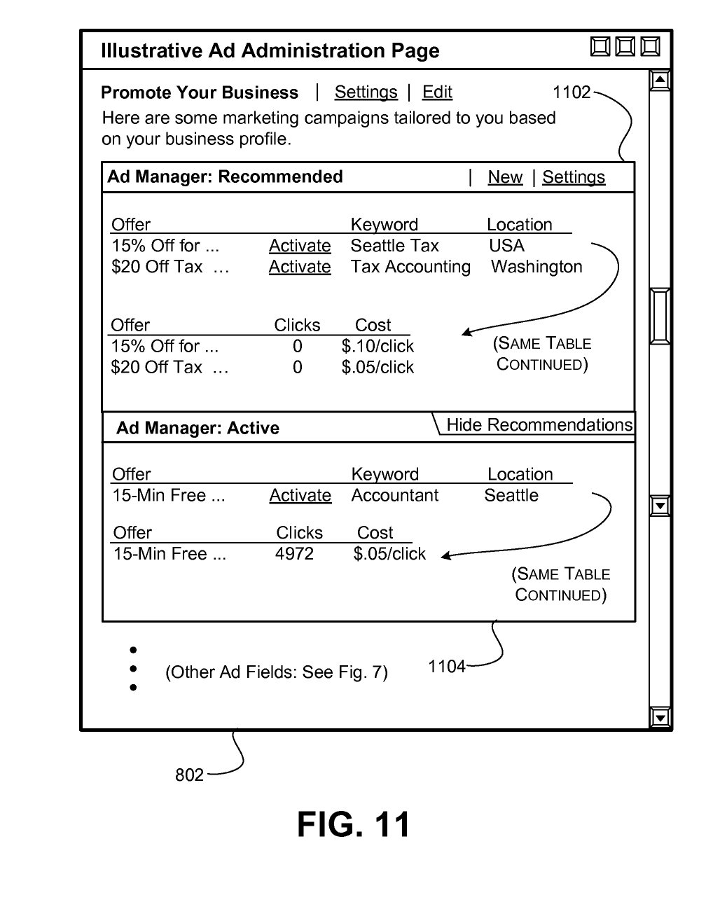

FIG. 11 shows another depiction of the ad administrative page 802 of FIG. 8. In this scenario, assume that the user has activated the ad program corresponding to the ad page 1002 of FIG. 10. As stated, this ad program is a network-related ad program that invites user to sign up for a free 15-minute consultation. In FIG. 11, the entry associated with this ad program is appropriately moved from a recommended ad section 1102 to an active ad section 1104. The user can be keep abreast of the success of the ad by noting how many clicks it has received from customers, and so on.

To repeat, the set-up facilitating system 102 can allow a user to generate other resources (e.g., in addition to those mentioned above). Further, the set-up facilitating system 102 can use any type of user interface presentations, not limited to those representative pages described above.

B. Illustrative Flowcharts

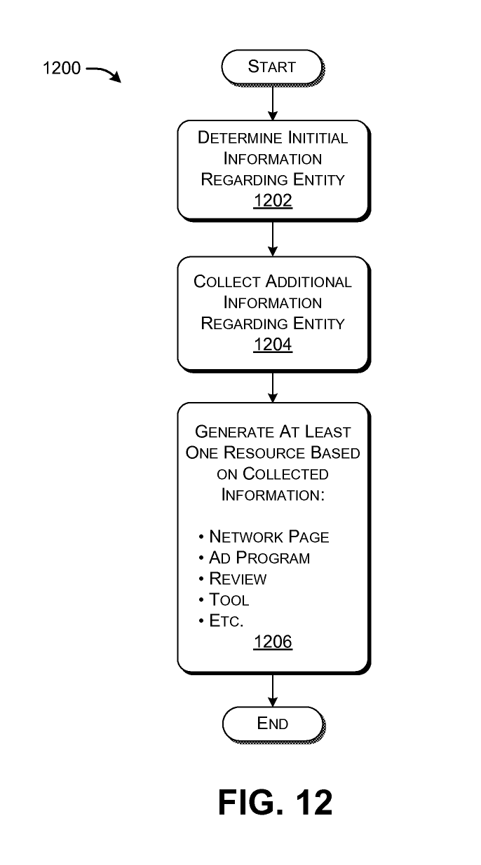

FIG. 12 illustrates the operation of the set-up facilitating system 102 in flowchart form. To facilitate discussion, certain operations are described in FIG. 12 as constituting distinct blocks performed in a certain order. Such implementations are illustrative and non-limiting. Certain blocks described herein can be grouped together and performed in a single operation, and certain blocks can be performed in an order that differs from the order employed in the examples set forth in this disclosure. The blocks shown in the flowcharts can be implemented by software, firmware, hardware, manual processing, any combination of these implementations, and so on.

As the functions described in FIG. 12 have already been set forth above, the following explanation will serve as a summary and review of those functions.

FIG. 12 shows a procedure 1200 for automatically provisioning one or more resources using the set-up facilitating system 102 of FIG. 1.

In block 1202, the set-up facilitating system 102 receives seed information regarding the entity. In one merely representative case, the seed information may provide the name and zip code of the entity. The user may supply this initial seed information as part of a registration process.

In block 1204, the set-up facilitating system 102 determines additional information regarding the entity. The information collecting module 110 performs this task by extracting relevant information from the information sources 108. The combination of the initial seed information and the additional information is referred to as entity information.

In block 1206, the set-up facilitating system 102 generates at least one resource based on the entity information. One resource is a network (e.g., web) site or sites. Another resource entails the presentation of one or more customer reviews associated with the entity, giving the user the option to take various actions regarding the review(s). Another resource comprises a recommended ad program or programs. Another resource comprises one or more services that can be used by the entity. Block 1206 may entail generating yet other resources. Block 1206 may also encompass a step of receiving editing revisions from the user.

C. Representative Processing Functionality

FIG. 13 sets forth illustrative electrical data processing functionality or equipment 1300 (simply “processing functionality” below) that can be used to implement any aspect of functions described above. With reference to FIG. 3, for instance, the processing functionality 1300 can be used to implement the set-up facilitating system 102 or any component thereof. With reference to the same figure, the processing functionality 1300 can also be used to implement any of the user electronic devices (302, 304, . . . 306). The processing functionality 1300 may correspond to a general purpose computing device, a special purpose computing device, or any other implementation.

The processing functionality 1300 can include volatile and non-volatile memory, such as RAM 1302 and ROM 1304, as well as one or more processing devices 1306. The processing functionality 1300 also optionally includes various media devices 1308, such as a hard disk module, an optical disk module, and so forth. The processing functionality 1300 can perform various operations identified above when the processing device(s) 1306 executes instructions that are maintained by memory (e.g., RAM 1302, ROM 1304, or elsewhere). More generally, instructions and other information can be stored on any computer-readable medium 1310, including, but not limited to, static memory storage devices, magnetic storage devices, optical storage devices, and so on. The term “computer-readable medium” also encompasses plural storage devices. The term “computer-readable medium” also encompasses signals transmitted from a first location to a second location, e.g., via wire, cable, wireless transmission, etc. The term “logic” describes instructions for performing identified tasks; for example, resource-providing logic corresponds to instructions associated with the tasks performed by the resource-providing module 104 as described above.

The processing functionality 1300 also includes an input/output module 1312 for receiving various inputs from a user (via input modules 1314), and for providing various outputs to the user (via output modules). One particular output mechanism may include a presentation module 1316 and an associated graphical user interface (GUI) 1318. The processing functionality 1300 can also include one or more network interfaces 1320 for exchanging data with other devices via one or more communication conduits 1322. One or more communication buses 1324 communicatively couple the above-described components together.

In closing, the description may have described various concepts in the context of illustrative challenges or problems. This manner of explication does not constitute an admission that others have appreciated and/or articulated the challenges or problems in the manner specified herein.

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for configuring one or more resources on behalf of an entity, the method being performed on data processing equipment, comprising:
determining initial information regarding the entity;
based on the initial information, collecting additional information regarding the entity from at least one information source, the initial information and the additional information together comprising entity information; and
based on the entity information, generating at least one resource for the entity.

2. The method of claim 1, wherein the entity is a business entity.

3. The method of claim 1, wherein the initial information corresponds to a name and mailing code of the entity.

4. The method of claim 1, wherein said at least one information source comprises at least one network-accessible information source that provides public information regarding the entity.

5. The method of claim 1, wherein said at least one resource that is generated for the entity comprises a network-accessible page, wherein said generating comprises using the entity information to automatically provide the network-accessible page.

6. The method of claim 1, wherein said at least one resource that is generated for the entity comprises review information, wherein said generating comprises:
using the entity information to identify one or more reviews associated with the entity; and
in response to an instruction from the user, incorporating said one or more reviews into a network-accessible page provided by the entity.

7. The method of claim 6, wherein said one or more reviews that are associated with the entity are extracted from one or more network-accessible information sources which provide review information.

8. The method of claim 1, wherein said at least one resource that is generated for the entity comprises an ad program, wherein said generating comprises:
using the entity information to provide at least one ad program recommendation to a user; and
invoking an ad program associated with an ad program recommendation selected by the user.

9. The method of claim 8, wherein said at least one ad program recommendation provides details regarding a network-implemented ad program.

10. The method of claim 9, wherein the details describe an offer to be presented by the network-implemented ad program.

11. The method of claim 9, wherein the details identify at least one network-accessible page to be presented to an ad recipient by the network-implemented ad program.

12. The method of claim 9, wherein the details identify one or more keywords associated with the network-implemented ad program, and a cost associated with the network-implemented ad program.

13. The method of claim 8, wherein said at least one ad program recommendation provides details regarding a direct mail ad campaign.

14. The method of claim 1, wherein said at least one resource that is generated for the entity comprises a tool for use by the entity in performing a function.

15. A set-up facilitating system for configuring one or more resources on behalf of an entity, comprising:
an information collecting module configured to use initial information as a seed to collect additional information regarding an entity, the additional information being collected from at least one information source, the initial information and the additional information together comprising entity information; and
a resource-providing module configured to use the entity information to generate at least one resource for the entity.

16. The set-up facilitating system of claim 15, wherein the resource-providing module includes a site-generating module, wherein the site-generating module is configured to provide, as said at least one resource, a network-accessible page.

17. The set-up facilitating system of claim 15, wherein the resource-providing module includes a recommendation-processing module, wherein the recommendation-processing module is configured to provide, as said at least one resource, one or more reviews that are extracted from one or more network-accessible information sources.

18. The set-up facilitating system of claim 15, wherein the resource-providing module includes an ad program-generating module, wherein the ad program-generating module is configured to provide, as said at least one resource, an ad program recommendation.

19. The set-up facilitating system of claim 15, wherein the resource-providing module includes a service-generating module, wherein the service-generating module is configured to provide, as said at least one resource, a tool for use by the entity.

20. A computer-readable medium for storing computer-readable instructions, the computer-readable instructions providing a set-up facilitating system when executed by one or more processing devices, the computer-readable instructions comprising:
information collection logic configured to use initial information as a seed to collect additional information regarding an entity, the additional information being collected from at least one information source, the initial information and the additional information together comprising entity information; and
resource-providing logic configured to use the entity information to generate at least one resource for the entity,
wherein the feature-providing logic comprises:
site-generating logic configured to provide, as said at least one resource, a network-accessible page;
recommendation-processing logic configured to provide, as said at least one resource, one or more reviews that are extracted from one or more network-accessible information sources;
ad program-generating logic configured to provide, as said at least one resource, an ad program recommendation; and
service-generating logic configured to provide, as said at least one resource, a tool for use by the entity.
